(19) United States
(12) Patent Application Publication
(10) Pub. No.: US 2022/0027910 A1
(43) Pub. Date: Jan. 27, 2022

(54) REFUNDING BUILT-IN SHIPPING CHARGES

(71) Applicants: NTNG Inc., Seoul (KR); Vitabrid Inc., Los Angeles, CA (US)

(72) Inventor: Hojun Kim, Seoul (KR)

(21) Appl. No.: 17/334,300

(22) Filed: May 28, 2021

Related U.S. Application Data
(60) Provisional application No. 63/054,605, filed on Jul. 21, 2020.

(51) Int. Cl. G06Q 20/40; G06Q 10/08; G06Q 30/02; G06Q 30/04

(52) U.S. Cl. CPC G06Q 20/407; G06Q 30/04; G06Q 30/0283; G06Q 10/08345

(57) ABSTRACT

Providing refund of built-in shipping charges for consolidation of the delivery of items in one delivery unit, including: receiving a consumer ID of the online shopper, the selected items, and a consolidation selection;

determining whether the online shopper identified by the consumer ID opted to receive the selected items in one delivery unit; determining a total price of the selected items and comparing the total price against a preset amount, when it is determined that the online shopper has opted to receive the selected items in one delivery unit; calculating a total refund as a sum of built-in shipping charges of all selected items, if the total price is more than the preset amount; calculating a total refund as a sum of built-in shipping charges of all selected items minus one built-in shipping charge, if the total price is less than or equal to the preset amount.

### CROSS-REFERENCE TO RELATED APPLICATIONS

This application claims the benefit of priority under 35 U.S.C. § 119(e) of: co-pending U.S. Provisional Patent Application No. 63/054,605, filed Jul. 21, 2020, entitled “E-commerce System to Refund Built-in Shipping Costs”. The disclosure of the above-referenced application is incorporated herein by reference.

### BACKGROUND

### Field

The present disclosure relates to methods and systems for e-commerce pricing, and more specifically, to refunding built-in shipping charges.

### Background

With increased online shopping, price competition among online sellers is increasing with proliferation of price comparison sites that offer lowest prices for products selected by online shoppers. Thus, the online sellers may be searching for different ways to lower the prices of products to entice the online shoppers.

### SUMMARY

The present disclosure provides for an e-commerce pricing which refunds built-in shipping charges.

In one implementation, a method for providing refund of built-in shipping charges for consolidation of the delivery of items selected by an online shopper from an online seller into one delivery unit is disclosed. The method includes: receiving a consumer ID of the online shopper, the selected items, and a consolidation selection; querying the consolidation selection made by the online shopper to determine whether the online shopper identified by the consumer ID opted to receive the selected items in one delivery unit; determining a total price of the selected items and comparing the total price against a preset amount, by a consumer service provider, when it is determined that the online shopper has opted to receive the selected items in one delivery unit; calculating a total refund, by the consumer service provider, as a sum of built-in shipping charges of all selected items, if the total price is more than the preset amount; calculating a total refund, by the consumer service provider, as a sum of built-in shipping charges of all selected items minus one built-in shipping charge, if the total price is less than or equal to the preset amount; and sending the total refund to the online seller.

In one implementation, the method further includes sending to the online seller a total amount to pay by the online shopper by subtracting the total refund from the total price of the selected items. In one implementation, receiving the selected items in one delivery unit includes delivering the selected items in one box or multiple boxes delivered at the same time using a single delivery means. It should be noted that when the selected items are received in one delivery unit, only one delivery charge is made to the online shopper, whether the delivery is made in one box or multiple boxes. In one implementation, the one built-in shipping charge kept is the most expensive built-in shipping charge. In one implementation, the one built-in shipping charge kept is the least expensive built-in shipping charge.

In another implementation, another method for providing refund of built-in shipping charges for consolidation of the delivery of items selected by an online shopper from an online seller into one delivery unit is disclosed. The method includes: receiving a consumer ID of the online shopper, the selected items, and a consolidation selection; querying the consolidation selection made by the online shopper to determine whether the online shopper identified by the consumer ID opted to add the selected items to at least one periodically delivered item and to receive all items in one delivery unit; calculating a total refund, by the consumer service provider, as a sum of built-in shipping charges of all selected items, when it is determined that the online shopper opted to add the selected items to at least one periodically delivered item and to receive all items in one delivery unit; and sending the total refund to the online seller.

In one implementation, the at least one periodically delivered item is at least one monthly subscription item.

In yet another implementation, a system for providing refund of built-in shipping charges for consolidation of the delivery of items selected by an online shopper from an online seller into one delivery unit is disclosed. The system includes: a consumer service provider; a memory; a downloadable software module that operates on a mobile device, the software module including instructions to browse and select the items from the online seller and to receive a consolidation selection from the online shopper identified by a consumer ID; a processor coupled to the memory programmed with executable instructions, the processor configured to transmit product identifiers of the selected items, the consumer ID, and the consolidation selection to the consumer service provider, wherein the consumer service provider determines, from the consolidation selection, whether the online shopper identified by the consumer ID opted to receive the selected items in one delivery unit, wherein the consumer service provider determines a total price of the selected items and compares the total price against a preset amount, when it is determined that the online shopper has opted to receive the selected items in one delivery unit, wherein the consumer service provider calculates a total refund as a sum of built-in shipping charges of all selected items, if the total price is more than the preset amount, wherein the consumer service provider calculates a total refund as a sum of built-in shipping charges of all selected items minus one built-in shipping charge, if the total price is less than or equal to the preset amount, and wherein the consumer service provider sends the total refund to the online seller.

In one implementation, the receipt of the selected items in one delivery unit includes receipt of the selected items in one box or multiple boxes delivered at the same time using a single delivery means. It should be noted that when the selected items are received in one delivery unit, only one delivery charge is made to the online shopper, whether the delivery is made in one box or multiple boxes. In one implementation, the one built-in shipping charge kept is the most expensive built-in shipping charge. In one implementation, the one built-in shipping charge kept is the least expensive built-in shipping charge.

In another implementation, a non-transitory computer-readable storage medium storing a computer program to provide refund of built-in shipping charges for consolidation of the delivery of items selected by an online shopper from an online seller into one delivery unit is disclosed. The computer program includes executable instructions that cause a computer to: receive a consumer ID of the online shopper, the selected items, and a consolidation selection; query the consolidation selection made by the online shopper to determine whether the online shopper identified by the consumer ID opted to receive the selected items in one delivery unit; determine a total price of the selected items and compare the total price against a preset amount, when it is determined that the online shopper has opted to receive the selected items in one delivery unit; calculate a total refund as a sum of built-in shipping charges of all selected items, if the total price is more than the preset amount; calculate a total refund as a sum of built-in shipping charges of all selected items minus one built-in shipping charge, if the total price is less than or equal to the preset amount; and send the total refund to the online seller.

In one implementation, the executable instructions further include executable instructions that cause the computer to send to the online seller a total amount to pay by the online shopper by subtracting the total refund from the total price of the selected items. In one implementation, the executable instructions that cause the computer to receive the selected items in one delivery unit includes executable instructions that cause the computer to deliver the selected items in one box or multiple boxes delivered at the same time using a single delivery means. In one implementation, the one built-in shipping charge kept is the most expensive built-in shipping charge. In one implementation, the one built-in shipping charge kept is the least expensive built-in shipping charge.

Other features and advantages should be apparent from the present description which illustrates, by way of example, aspects of the disclosure.

### BRIEF DESCRIPTION OF THE DRAWINGS

The details of the present disclosure, both as to its structure and operation, may be gleaned in part by study of the appended drawings, in which like reference numerals refer to like parts, and in which:

FIG. 1 is a block diagram of an e-commerce system for providing refund of built-in shipping charges for combining the delivery of multiple items into one delivery unit in accordance with one implementation of the present disclosure;

FIG. 2 is a flow diagram of an e-commerce method for selecting to combine the delivery of multiple items into one delivery unit to receive refund of built-in shipping charges for in accordance with one implementation of the present disclosure;

FIG. 3 is a flow diagram of an e-commerce method for providing refund of built-in shipping charges for consolidating the delivery of multiple selected items into one delivery unit by the consumer service provider in accordance with one implementation of the present disclosure;

FIG. 4 is a flow diagram of an e-commerce method for providing refund of built-in shipping charges for combining the delivery of selected items into one delivery unit by the consumer service provider in accordance with another implementation of the present disclosure;

FIG. 5A is a representation of a computer system and a user in accordance with an implementation of the present disclosure; and

FIG. 5B is a functional block diagram illustrating the computer system hosting an e-commerce application in accordance with an implementation of the present disclosure.

### DETAILED DESCRIPTION

As noted above, the price competition among online sellers are increasing and the online sellers are searching for different ways to lower the prices of products to entice the online shoppers. In some cases, there may be shipping charges built into the prices of products, which may be used as an incentive for additional discount if the online shoppers are willing to accept changes to the delivery means and/or shipping methods.

Certain implementations of the present disclosure include several different ways to refund the shipping charges built into the prices of products for additional discount to the online shoppers. In one implementation, the online shopper receives refund of the additional built-in shipping charges for combining the delivery of multiple items into one delivery unit. The term “one delivery unit” refers to delivering the multiple items all at once using a single delivery means (e.g., in one delivery vehicle). In another implementation, built-in shipping charges for all of the items added to the periodically delivered item(s) (e.g., under monthly subscription) are refunded or discounted to the online shopper.

After reading the descriptions recited in this section, it will become apparent how to implement the disclosure in various implementations and applications. Although various implementations of the present disclosure will be described herein, it is understood that these implementations are presented by way of example only, and not limitation. As such, the detailed description of various implementations should not be construed to limit the scope or breadth of the present disclosure.

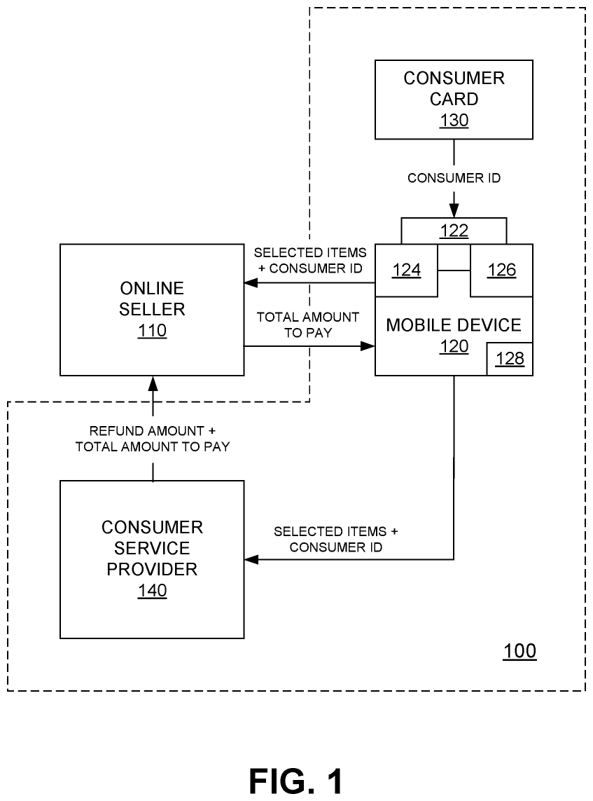

FIG. 1 is a block diagram of an e-commerce system 100 for providing refund of built-in shipping charges for combining the delivery of multiple items into one delivery unit in accordance with one implementation of the present disclosure. In the illustrated implementation of FIG. 1, the system 100 includes interconnection of a mobile device 120 belonging to an online shopper, a consumer card 130, and a consumer service provider 140. The system 100 uses the mobile device 120 to read an identifier of the consumer (“consumer ID”) from a consumer card 130. The system 100 interacts with an online seller 110.

In one implementation, the consumer card 120 is issued by the consumer service provider 140. In another implementation, the consumer card 130 is issued by a third-party credit company not related to the consumer service provider 140. In yet another implementation, the consumer card 130 is issued by the online seller 110 and the consumer service provider 140 is a part of or owned by the online seller 110. In a further implementation, the consumer card 130 is an electronic token or identifier specifically generated by the consumer service provider 140 for the online seller to be used on the mobile device 120. In this implementation, the consumer card 130 may be an electronic identifier identifying the online shopper and residing on the mobile device 120

In one implementation, the consumer ID is read using the camera on the mobile device 120. In another implementation, the consumer ID is read by a code reader coupled to the mobile device 120. In one implementation, the consumer ID is a number printed on the consumer card 130. In another implementation, the consumer ID is a bar code or QR code printed on the consumer card 130. In yet another implementation, the consumer ID is a code embedded in the consumer card 130 which must be read by the mobile device 120 and transmitted to the consumer service provider 140 to verify the consumer ID. In one implementation, the consumer card 130 is a credit card issued by the consumer service provider.

In one implementation, the mobile device 120 is a mobile phone including a built-in camera and an interface port for connecting other communication devices such as a code reader 122. In another implementation, the mobile device 120 is a laptop computer including a built-in camera and an interface port for connecting other communication devices such as a code reader 122. In yet another implementation, the mobile device 120 is a desktop computer having an interface port for connecting other communication devices such as a code reader 122. Thus, in the case of the desktop computer, the device 120 is usually stationary.

In one implementation, the online seller 110 is an online merchant with fixed website address(es) having multiple pages of merchandises for sale on the Internet. Prices for the merchandises are set after the consumer selects product(s) and submits the consumer ID. In another implementation, the online seller 110 is a private online distributor showing merchandises for sale at the request of the consumer.

In one implementation, the consumer service provider 140 is a service provider, which manages and/or monitors the online purchases of the online shopper identified by the consumer ID, and provides the online seller 110 with the purchase status of the online shopper. For example, the purchase status may provide the online seller 110 with information on how much in refund the online shopper should receive for combining the delivery of multiple items into one delivery unit.

In another implementation, the consumer service provider 140 is an application installed on the mobile device 120. In one implementation, the mobile device 120 includes: an application performing the functions of the consumer service provider 140; a memory 124; a downloadable software module 128 that operates on the mobile device 120 to browse and select products from the online seller 110; and a processor 126 coupled to the memory 124 programmed with executable instructions, including a consumer card reader 122 for obtaining the consumer ID from the consumer card 130. In one implementation, the application manages and/or monitors the online purchases of the online shopper made using the mobile device 120. In another implementation, the application also provides the online seller 110 with the purchase status of the online shopper, including information on how much in refund the online shopper receives for combining the delivery of multiple items into one delivery unit.

In the illustrated implementation of FIG. 1, the code reader 122 of the mobile device 120 reads the consumer ID of the online shopper from the consumer card 130. The online shopper uses the mobile device 120 to browse the online shopping mall of the online seller 110 and selects items to buy. The mobile device 120 uses the downloadable software module 128, the memory 124, and the processor 126 to enable the online shopper to browse and select items to buy from the online seller 110. Once the online shopper has selected all of the items to buy from the online seller 110, the mobile device 120 sends the selected items and the consumer ID to the consumer service provider 140 and the online seller 110. The consumer service provider 140 determines the amount to be refunded (from the built-in shipping charges) to the online shopper who is identified by the consumer ID for the items that are selected to be shipped to the online shopper in one delivery unit. The refund amount and the total amount to pay are then forwarded to the online seller 110, which sends the total amount to pay by the online shopper to the mobile device 120. In response, the online shopper may choose the form of payment for the total amount such as a credit card.

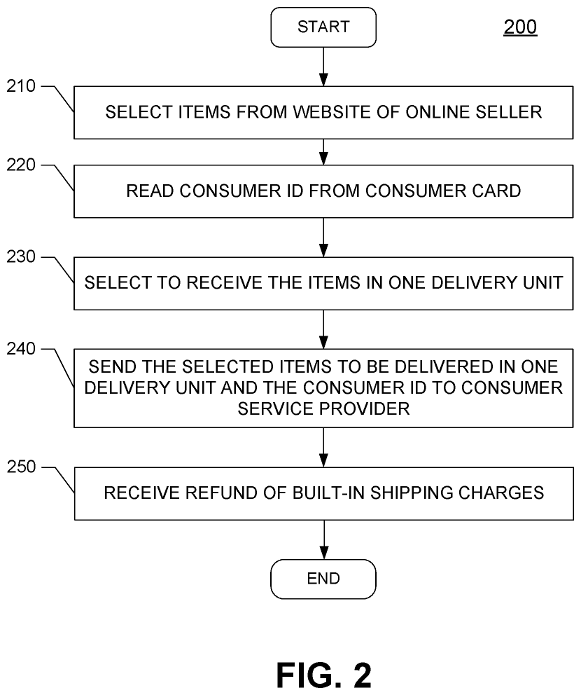

FIG. 2 is a flow diagram of an e-commerce method 200 for selecting to combine the delivery of multiple items into one delivery unit to receive refund of built-in shipping charges for in accordance with one implementation of the present disclosure. In the illustrated implementation of FIG. 2, the online shopper uses the mobile device 120 to select items from the online shopping mall of the online seller 110, at step 210. The mobile device 120 reads the consumer ID of the online shopper, at step 220. The online shopper selects, at step 230, to receive the selected items in one delivery unit. The mobile device 120 then sends, at step 240, the selected items to be delivered in one delivery unit and the consumer ID to the consumer service provider. Finally, the mobile device 120 receives, at step 250, the refund of the built-in shipping charges from the online seller. In one implementation, the online shopper gets charged for the total price of the selected items (including the built-in shipping charges), but is refunded for the built-in shipping charges calculated by the consumer service provider. In another implementation, the online shopper gets charged for total price of the selected items minus the calculated refund.

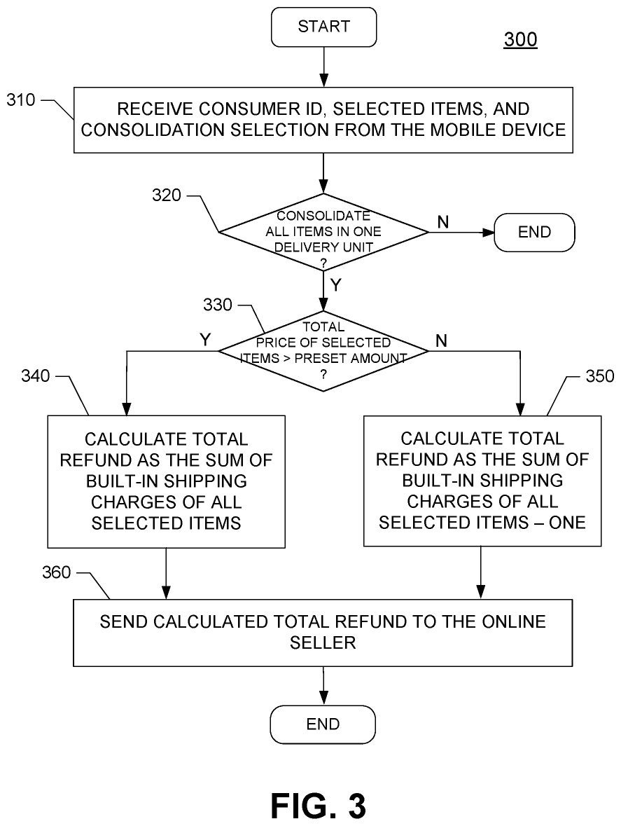

FIG. 3 is a flow diagram of an e-commerce method 300 for providing refund of built-in shipping charges for consolidating the delivery of multiple selected items into one delivery unit by the consumer service provider in accordance with one implementation of the present disclosure. In the illustrated implementation of FIG. 3, the online shopper receives refund of the additional built-in shipping charges for combining the delivery of multiple items into one delivery unit. In this implementation, only one built-in shipping charge is kept and the built-in shipping charges for the remaining items are refunded or discounted to the online shopper. Accordingly, more discount results from combining more items into one delivery unit. The refund is possible because whether the online shopper purchases one item or two or more items, the shipping cost to the online seller does not increase much since the items are packed and delivered to the online shopper in one delivery unit (e.g., in one box or multiple boxes delivered at the same time using a single delivery means).

The illustrated implementation of FIG. 3 refers to refunding a certain amount to the online shopper for purchasing multiple items (e.g., advertised as having “free shipping”) from an Internet shopping mall. When the online shopper purchases the multiple items from the online seller, the consumer service provider calculates the amount of refund of the built-in (or “hidden”) shipping charges for combining the delivery of multiple items into one delivery unit.

In the illustrated implementation of FIG. 3, the consumer ID, the selected items, and the consolidation selection are received, at step 310, from the mobile device 120 at the consumer service provider 140. The consolidation selection by the online shopper is queried, at step 320, to determine whether the online shopper identified by the consumer ID opted to receive the selected items in one delivery unit. If it is determined that the online shopper has opted to receive the selected items in one delivery unit, the consumer service provider 140 determines the total price of the selected items and compares the total price against a preset amount, at step 330. If the total price is more than the preset amount, the consumer service provider calculates the total refund as the sum of the built-in shipping charges of all selected items (second implementation described below), at step 340. Otherwise, if the total price is less than or equal to the preset amount, the consumer service provider calculates the total refund as the sum of the built-in shipping charges of all selected items minus one (first implementation described below), at step 350. The calculated total refund is then sent, at step 360, to the online seller 110. In one implementation, the online shopper gets charged for the total price of the selected items (including the built-in shipping charges), but is refunded for the built-in shipping charges calculated by the consumer service provider. In another implementation, the online shopper gets charged for total price of the selected items minus the calculated refund.

In a first implementation, only one built-in shipping charge is kept and the built-in shipping charges for the remaining items are refunded or discounted to the online shopper. In one implementation, one built-in charge that is kept is the most expensive built-in shipping charge. In another implementation, one built-in charge that is kept is the least expensive built-in shipping charge.

In the first implementation, as items selected for purchase by the online shopper are put into the shopping cart, the price and the built-in shipping charge for each of the selected items are calculated. When all of the selected items have been processed, the prices of all of the selected items are totaled to produce a total price and all of the built-in shipping charges minus one are totaled to produce a total shipping charge to be refunded. The consumer service provider then calculates the total amount to pay by the online shopper by subtracting the total shipping charge from the total price.

In one example of the first implementation, an Internet shopping mall that offers free shipping includes multiple items having prices with built-in shipping charges. If an online shopper places three serums ($30 per each serum) into a shopping cart and selects the serums to be shipped in one delivery unit, the consumer service provider calculates the total price for the serums as $90 (=$30×3). The consumer service provider also calculates the built-in shipping charge for each item as $7.50. Thus, the total shipping charge to be refunded for the three serums is calculated to be $15 (=($7.50×3)−($7.50×1)). The consumer service provider then calculates the total amount ($75) to pay by the online shopper by subtracting the total shipping charge ($15) from the total price ($90).

In a second implementation, the built-in shipping charges for all of the selected items to be delivered in one delivery unit are refunded or discounted to the online shopper when the total price of the selected items exceeds a preset amount. In one example of the second implementation, an Internet shopping mall that offers free shipping includes multiple items having prices with built-in shipping charges. In this example, the consumer service provider has set the preset amount to be $100. If an online shopper places four serums ($30 per each serum) into a shopping cart and selects the serums to be shipped in one delivery unit, the consumer service provider calculates the total price for the serums as $120 (=$30×4), which is above the preset amount of $100. The consumer service provider also calculates the built-in shipping charge for each item as $7.50. Thus, in the second implementation, the total shipping charge to be refunded for the four serums is calculated to be $30 (=$7.50×4). The consumer service provider then calculates the total amount ($90) to pay by the online shopper by subtracting the total shipping charge ($30) from the total price ($120).

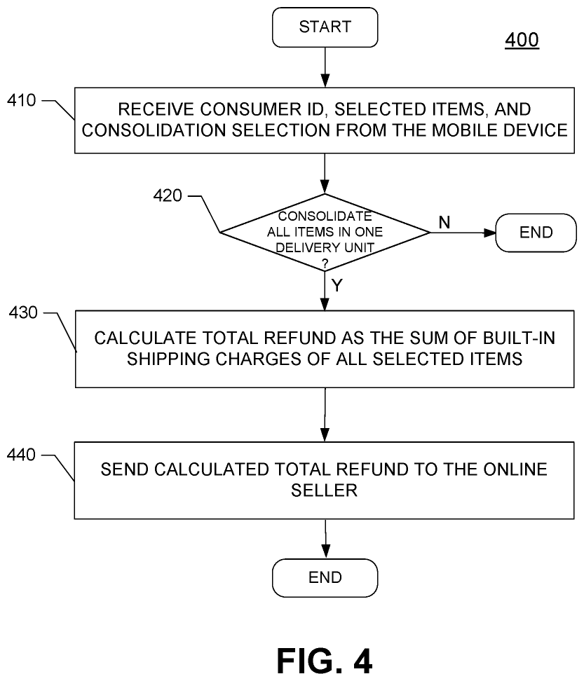

FIG. 4 is a flow diagram of an e-commerce method 400 for providing refund of built-in shipping charges for combining the delivery of selected items into one delivery unit by the consumer service provider in accordance with another implementation of the present disclosure. In the illustrated implementation of FIG. 4, built-in shipping charges for all of the items added to the periodically delivered item(s) (e.g., under monthly subscription) are refunded or discounted to the online shopper. Thus, in this implementation, the added items and the periodically delivered item(s) are all combined into one delivery unit.

The illustrated implementation of FIG. 4 refers to refunding a certain amount to the online shopper for purchasing selected items from an Internet shopping mall and accepting a condition to add the selected items to periodically delivered item(s) so that all of the items are combined into one delivery unit. In this case, the certain amount refunded to the online shopper includes the built-in shipping charges for all of the selected items.

In the illustrated implementation of FIG. 4, all of the built-in shipping charges for the selected items are refunded or discounted to the online shopper when the selected items are added to the periodically delivered item(s) so that all of the items (including the selected items and the periodically delivered item(s)) are combined into one delivery unit. In this implementation, as items selected for purchase by the online shopper are put into the shopping cart, the price and the built-in shipping charge for each of the selected items are calculated. When all of the selected items have been processed, the prices of all of the selected items are totaled to produce a total price and all of the built-in shipping charges are totaled to produce a total shipping charge to be refunded. The consumer service provider then calculates the total amount to pay by the online shopper by subtracting the total shipping charge from the total price and the total amount to pay to the charges for the periodically delivered item(s), which may or may not include the built-in shipping charges.

As described above, in the illustrated implementation of FIG. 4, the consumer ID, the selected items, and the consolidation selection are received, at step 410, from the mobile device 120 at the consumer service provider 140. The consolidation selection by the online shopper is queried, at step 420, to determine whether the online shopper identified by the consumer ID opted to add the selected items to the periodically delivered item(s) so that all of the items are combined into one delivery unit. If it is determined that the online shopper has opted to receive all items (including the selected items and the periodically delivered item(s)) in one delivery unit, the consumer service provider calculates the total refund as the sum of the built-in shipping charges of all selected items, at step 430. The calculated total refund is then sent, at step 440, to the online seller 110. In one implementation, the online shopper gets charged for the total price of the selected items (including the built-in shipping charges), but is refunded for the built-in shipping charges calculated by the consumer service provider. In another implementation, the online shopper gets charged for total price of the selected items minus the calculated refund.

In one example of the illustrated implementation of FIG. 4, an Internet shopping mall that offers free shipping includes multiple items having prices with built-in shipping charges. If an online shopper places three serums ($30 per each serum) into a shopping cart and selects the serums to be shipped with the periodically delivered item(s) (e.g., a hair shampoo at the cost of $50 per month) in one delivery unit, the consumer service provider calculates the total price for the serums as $90 (=$30×3). The consumer service provider also calculates the built-in shipping charge for each item as $7.50. Thus, the total shipping charge to be refunded for the three serums is calculated to be $22.50 (=$7.50×3). The consumer service provider then calculates the total amount ($67.50) to pay by the online shopper (for the selected items) by subtracting the total shipping charge ($22.50) from the total price ($90). This total amount ($67.50) is added to the monthly total amount of $50 (for the hair shampoo) for the entire payment amount of $117.50.

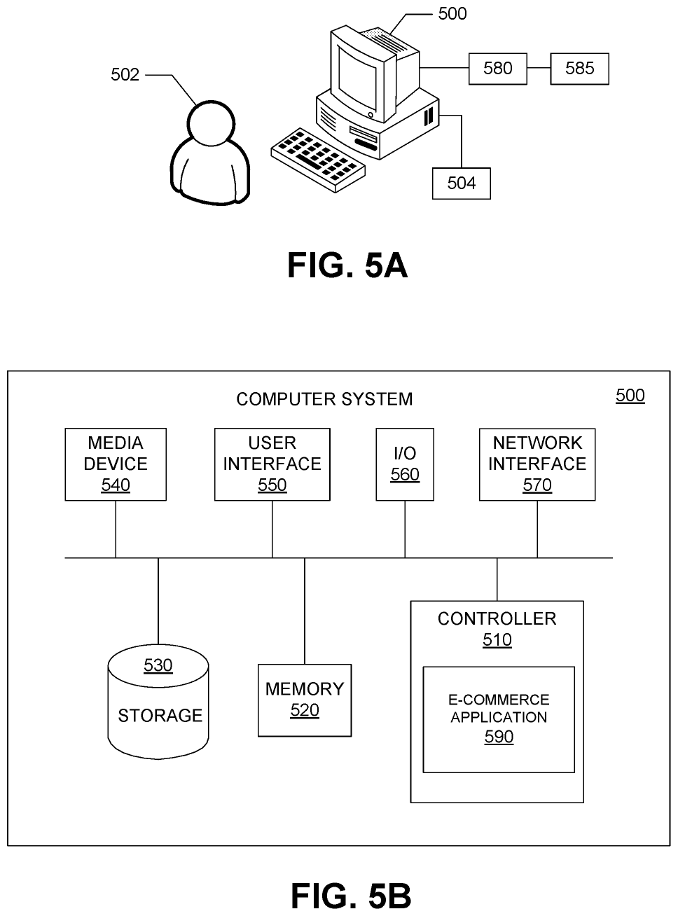

FIG. 5A is a representation of a computer system 500 and a user 502 in accordance with an implementation of the present disclosure. The user 502 uses the computer system 500 to implement an e-commerce application 590 as illustrated and described with respect to the system 100 of the block diagram shown in FIG. 1 and the methods 200, 300, 400 illustrated in FIGS. 2, 3, and 4.

The computer system 500 stores and executes the e-commerce application 590 of FIG. 5B. In addition, the computer system 500 may be in communication with a software program 504. Software program 504 may include the software code for the e-commerce application 590. Software program 504 may be loaded on an external medium such as a CD, DVD, or a storage drive, as will be explained further below.

Furthermore, computer system 500 may be connected to a network 580. The network 580 can be connected in various different architectures, for example, client-server architecture, a Peer-to-Peer network architecture, or other type of architectures. For example, network 580 can be in communication with a server 585 that coordinates engines and data used within the e-commerce application 590. Also, the network can be different types of networks. For example, the network 580 can be the Internet, a Local Area Network or any variations of Local Area Network, a Wide Area Network, a Metropolitan Area Network, an Intranet or Extranet, or a wireless network.

FIG. 5B is a functional block diagram illustrating the computer system 500 hosting the e-commerce application 590 in accordance with an implementation of the present disclosure. A controller 510 is a programmable processor and controls the operation of the computer system 500 and its components. The controller 510 loads instructions (e.g., in the form of a computer program) from the memory 520 or an embedded controller memory (not shown) and executes these instructions to control the system. In its execution, the controller 510 provides the e-commerce application 590 with a software system, such as to enable the creation and configuration of engines and data extractors within the e-commerce application 590. Alternatively, this service can be implemented as separate hardware components in the controller 510 or the computer system 500.

Memory 520 stores data temporarily for use by the other components of the computer system 500. In one implementation, memory 520 is implemented as RAM. In one implementation, memory 520 also includes long-term or permanent memory, such as flash memory and/or ROM.

Storage 530 stores data either temporarily or for long periods of time for use by the other components of the computer system 500. For example, storage 530 stores data used by the e-commerce application 590. In one implementation, storage 530 is a hard disk drive.

The media device 540 receives removable media and reads and/or writes data to the inserted media. In one implementation, for example, the media device 540 is an optical disc drive.

The user interface 550 includes components for accepting user input from the user of the computer system 500 and presenting information to the user 502. In one implementation, the user interface 550 includes a keyboard, a mouse, audio speakers, and a display. The controller 510 uses input from the user 502 to adjust the operation of the computer system 500.

The I/O interface 560 includes one or more I/O ports to connect to corresponding I/O devices, such as external storage or supplemental devices (e.g., a printer or a PDA). In one implementation, the ports of the I/O interface 560 include ports such as: USB ports, PCMCIA ports, serial ports, and/or parallel ports. In another implementation, the I/O interface 560 includes a wireless interface for communication with external devices wirelessly.

The network interface 570 includes a wired and/or wireless network connection, such as an RJ-45 or “Wi-Fi” interface (including, but not limited to 802.11) supporting an Ethernet connection.

The computer system 500 includes additional hardware and software typical of computer systems (e.g., power, cooling, operating system), though these components are not specifically shown in FIG. 5B for simplicity. In other implementations, different configurations of the computer system can be used (e.g., different bus or storage configurations or a multi-processor configuration).

In one implementation, the system 100 is a system configured entirely with hardware including one or more digital signal processors (DSPs), general purpose microprocessors, application specific integrated circuits (ASICs), field programmable gate/logic arrays (FPGAs), or other equivalent integrated or discrete logic circuitry. In another implementation, the system 100 is configured with a combination of hardware and software.

The description herein of the disclosed implementations is provided to enable any person skilled in the art to make or use the present disclosure. Numerous modifications to these implementations would be readily apparent to those skilled in the art, and the principals defined herein can be applied to other implementations without departing from the spirit or scope of the present disclosure. Thus, the present disclosure is not intended to be limited to the implementations shown herein but is to be accorded the widest scope consistent with the principal and novel features disclosed herein.

Various implementations of the present disclosure are realized in electronic hardware, computer software, or combinations of these technologies. Some implementations include one or more computer programs executed by one or more computing devices. In general, the computing device includes one or more processors, one or more data-storage components (e.g., volatile or non-volatile memory modules and persistent optical and magnetic storage devices, such as hard and floppy disk drives, CD-ROM drives, and magnetic tape drives), one or more input devices (e.g., game controllers, mice and keyboards), and one or more output devices (e.g., display devices).

The computer programs include executable code that is usually stored in a persistent storage medium and then copied into memory at run-time. At least one processor executes the code by retrieving program instructions from memory in a prescribed order. When executing the program code, the computer receives data from the input and/or storage devices, performs operations on the data, and then delivers the resulting data to the output and/or storage devices.

Those of skill in the art will appreciate that the various illustrative modules and method steps described herein can be implemented as electronic hardware, software, firmware or combinations of the foregoing. To clearly illustrate this interchangeability of hardware and software, various illustrative modules and method steps have been described herein generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the present disclosure. In addition, the grouping of functions within a module or step is for ease of description. Specific functions can be moved from one module or step to another without departing from the present disclosure.

All features of each above-discussed example are not necessarily required in a particular implementation of the present disclosure. Further, it is to be understood that the description and drawings presented herein are representative of the subject matter which is broadly contemplated by the present disclosure. It is further understood that the scope of the present disclosure fully encompasses other implementations that may become obvious to those skilled in the art and that the scope of the present disclosure is accordingly limited by nothing other than the appended claims.

1. A method for providing refund of built-in shipping charges for consolidation of the delivery of items selected by an online shopper from an online seller into one delivery unit, the method comprising:
receiving a consumer ID of the online shopper, the selected items, and a consolidation selection;
querying the consolidation selection made by the online shopper to determine whether the online shopper identified by the consumer ID opted to receive the selected items in one delivery unit;
determining a total price of the selected items and comparing the total price against a preset amount, by a consumer service provider, when it is determined that the online shopper has opted to receive the selected items in one delivery unit;
calculating a total refund, by the consumer service provider, as a sum of built-in shipping charges of all selected items, if the total price is more than the preset amount;
calculating a total refund, by the consumer service provider, as a sum of built-in shipping charges of all selected items minus one built-in shipping charge, if the total price is less than or equal to the preset amount; and
sending the total refund to the online seller.

2. The method of claim 1, further comprising
sending to the online seller a total amount to pay by the online shopper by subtracting the total refund from the total price of the selected items.

3. The method of claim 1, wherein receiving the selected items in one delivery unit includes
delivering the selected items in one box or multiple boxes delivered at the same time using a single delivery means.

4. The method of claim 1, wherein the one built-in shipping charge kept is the most expensive built-in shipping charge.

5. The method of claim 1, wherein the one built-in shipping charge kept is the least expensive built-in shipping charge.

6. A method for providing refund of built-in shipping charges for consolidation of the delivery of items selected by an online shopper from an online seller into one delivery unit, the method comprising:
receiving a consumer ID of the online shopper, the selected items, and a consolidation selection;
querying the consolidation selection made by the online shopper to determine whether the online shopper identified by the consumer ID opted to add the selected items to at least one periodically delivered item and to receive all items in one delivery unit;
calculating a total refund, by the consumer service provider, as a sum of built-in shipping charges of all selected items, when it is determined that the online shopper opted to add the selected items to at least one periodically delivered item and to receive all items in one delivery unit; and
sending the total refund to the online seller.

7. The method of claim 6, wherein the at least one periodically delivered item is at least one monthly subscription item.

8. A system for providing refund of built-in shipping charges for consolidation of the delivery of items selected by an online shopper from an online seller into one delivery unit, the system comprising:
a consumer service provider;
a memory;
a downloadable software module that operates on a mobile device, the software module including instructions to browse and select the items from the online seller and to receive a consolidation selection from the online shopper identified by a consumer ID;
a processor coupled to the memory programmed with executable instructions, the processor configured to transmit product identifiers of the selected items, the consumer ID, and the consolidation selection to the consumer service provider,
wherein the consumer service provider determines, from the consolidation selection, whether the online shopper identified by the consumer ID opted to receive the selected items in one delivery unit,
wherein the consumer service provider determines a total price of the selected items and compares the total price against a preset amount, when it is determined that the online shopper has opted to receive the selected items in one delivery unit,
wherein the consumer service provider calculates a total refund as a sum of built-in shipping charges of all selected items, if the total price is more than the preset amount,
wherein the consumer service provider calculates a total refund as a sum of built-in shipping charges of all selected items minus one built-in shipping charge, if the total price is less than or equal to the preset amount, and
wherein the consumer service provider sends the total refund to the online seller.

9. The system of claim 8, wherein the receipt of the selected items in one delivery unit includes receipt of the selected items in one box or multiple boxes delivered at the same time using a single delivery means.

10. The system of claim 8, wherein the one built-in shipping charge kept is the most expensive built-in shipping charge.

11. The system of claim 8, wherein the one built-in shipping charge kept is the least expensive built-in shipping charge.

12. A non-transitory computer-readable storage medium storing a computer program to provide refund of built-in shipping charges for consolidation of the delivery of items selected by an online shopper from an online seller into one delivery unit, the computer program comprising executable instructions that cause a computer to:
receive a consumer ID of the online shopper, the selected items, and a consolidation selection;
query the consolidation selection made by the online shopper to determine whether the online shopper identified by the consumer ID opted to receive the selected items in one delivery unit;
determine a total price of the selected items and compare the total price against a preset amount, when it is determined that the online shopper has opted to receive the selected items in one delivery unit;
calculate a total refund as a sum of built-in shipping charges of all selected items, if the total price is more than the preset amount;
calculate a total refund as a sum of built-in shipping charges of all selected items minus one built-in shipping charge, if the total price is less than or equal to the preset amount; and
send the total refund to the online seller.

13. The non-transitory computer-readable storage medium of claim 12, further comprising executable instructions that cause the computer to send to the online seller a total amount to pay by the online shopper by subtracting the total refund from the total price of the selected items.

14. The non-transitory computer-readable storage medium of claim 12, wherein the executable instructions that cause the computer to receive the selected items in one delivery unit includes executable instructions that cause the computer to
deliver the selected items in one box or multiple boxes delivered at the same time using a single delivery means.

15. The non-transitory computer-readable storage medium of claim 12, wherein the one built-in shipping charge kept is the most expensive built-in shipping charge.

16. The non-transitory computer-readable storage medium of claim 12, wherein the one built-in shipping charge kept is the least expensive built-in shipping charge.
